(19) United States
(12) Patent Application Publication
(10) Pub. No.: US 2013/0017527 A1
(43) Pub. Date: Jan. 17, 2013

(54) METHOD AND APPARATUS FOR REWARDING A STUDENT

(71) Applicants: Chris Nguyen, Baltimore, MD (US); Chris Hoehn-Saric, Miami, FL (US); Eric Wenck, Baltimore, MD (US); Jeff Craig, Annapolis, MD (US); Lee Clinton, Baltimore, MD (US)

(72) Inventors: Chris Nguyen, Baltimore, MD (US); Chris Hoehn-Saric, Miami, FL (US); Eric Wenck, Baltimore, MD (US); Jeff Craig, Annapolis, MD (US); Lee Clinton, Baltimore, MD (US)

(73) Assignee: LEARNING CENTER OF THE FUTURE, INC., Baltimore, MD (US)

(21) Appl. No.: 13/180,063

(22) Filed: Jul. 11, 2011

(51) Int. Cl. G09B 7/00

(52) U.S. Cl. 434/362

(57) ABSTRACT

Methods and apparatus for rewarding students with redeemable tokens during a lesson are disclosed. As the student works through the lesson, the system determines whether any designated performance events occur based on the student's performance. Based on any occurrences of performance events, the system may accumulate one or more tokens for the student. The system may provide a visual indication of any tracked occurences of performance events. For example, for each occurrence of a performance event, the system increments a progress meter by a designated amount. When progress meter reaches a designated level, the system accumulates a designated quantity of tokens for the student. The amount by which the progress meter increments for each occurrence of a performance event may be based on the type of performance event which occurs. Different types of performance events may have different values or contribute differently toward the accumulation of tokens.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### TECHNICAL FIELD

The present application relates in general to a computer-implemented system which enables a student to accumulate redeemable tokens during a learning activity, such as a lesson or assignment, as an incentive for learning.

### BACKGROUND

It is known to provide students with incentives to continue to strive to meet their educational goals. Incentives in education come in a variety of forms. One type of incentive for continuing to learn includes getting recognition through receiving a better grade. Incentives may also include rewards. For example, if a student gets an A on a test, a relative, such as a parent, may pay the student five dollars, or a teacher may give the student an amount of free time or other privilege. Typically, these types of rewards are monitored and provided by the student's relatives or the student's teachers. Providing incentives, such as rewards, can make learning more fun and interesting for the student. Moreover, such rewards can encourage the student to work harder and to perform better. Rewards can increase the student's competitiveness because the student can compare with other students what he or she has achieved or what rewards he or she has have received.

Certain known systems use a token economy to motivate students. In such systems, points or tokens are awarded for correctly responding to questions or problems or for completing a lesson or assignment. The points or tokens may be redeemed to obtain rewards or prizes, such as toys, school supplies, lunch with the teacher, free time, etc. However, there are a number of drawbacks associated with these systems. For example, a student typically earns a point or token (or a set number of points or tokens) for each correct answer given on a lesson or assignment. Attributing the same number of points or tokens to each correct response discourages students from participating in certain types of assignments with slower question/response exchanges (e.g., assignments that include essay questions or word problems). Assignments having quicker answer/response exchanges (e.g., simple math problems) are typically favored over assignments in which the time required to present questions and receive corresponding responses is longer. Thus, in such systems, students may exhibit a preference for particular assignments based upon the quickness with which the student can accumulate points or tokens.

The proliferation of the computer has led to a number of computer-assisted educational systems. Computer-assisted learning systems can reward the student, such as with points or tokens, in a more immediate manner. This enhances the student's learning experience in a number of ways. For example, providing such immediate rewards when the student has answered a question or solved a problem helps with retention of knowledge. While the problem and the student's approach to correctly answering that problem are still fresh in the student's mind, a computer can provide the solution and a reward to the student. This helps the student to better retain what he or she has learned.

There is a continuing need for improved computer-implemented learning systems which provide students with benefits or rewards, such as redeemable tokens, to effectively encourage students in meeting their educational goals.

### SUMMARY

The system disclosed herein enables rewarding a student with redeemable electronic tokens as the student demonstrates proficiency in understanding the subject matter of a learning activity, such as a lesson.

In one embodiment, a lesson including a number of questions or problems is generated and displayed to a student on a student display device. The system enables the student to input answers or responses to the problems. As the student progresses through the lesson, the student's performance on the problems is tracked or monitored, and performance data indicative of the student's performance on the problems is collected and maintained. For example, performance data may include: (i) an amount of time required by the student to respond to each problem; (ii) whether a correct response was received from the student for each problem; and (iii) a level of difficulty associated with each problem.

Based on the performance data, the system determines whether any designated performance events occur. For example, the system may determine that a designated performance event occurs when: (i) a correct response is received from the student; (ii) a partially correct response is received from the student; (iii) a designated number of correct responses are received from the student; (iv) a designated number of consecutive correct responses are received from the student; (v) a correct response is received from the student within a designated amount of time; (vi) any other suitable performance criteria is satisfied; or (vii) any combination of these. Any occurrences of performance events in association with the lesson are tracked by the system. Based on any tracked occurrences of performance events, the system may award or accumulate a quantity of tokens for the student. The system may inform the student of the quantity of tokens awarded or accumulated by displaying them to the student.

In one embodiment, the system provides a visual indication of any tracked occurences of performance events. In one such embodiment, the system may employ one or more progress bars or meters displayed in association with a lesson. A progress bar or meter shows the student's progress toward achieving a certain goal. For example, a progress bar or meter shows the student's progress toward earning one token and/or a designated number of tokens, such as a number of tokens required to obtain a specific prize.

As the student works through the lesson, for each occurrence of a performance event, the system increments the progress meter by a designated amount. The amount by which the progress meter increments for each occurrence of a performance event may be a predefined amount or may be based on the type of performance event which occurs. That is, different types of performance events may cause the progress meter to increment by different amounts. For example, answering a question correctly causes the progress meter to increment by a first amount, and answering a question correctly within a predefined time period causes the progress meter to increment by a second, higher amount. In this manner, different types of performance events have different values (or contribute differently toward the accumulation of tokens). The amount by which the progress meter increments may be based on a level of difficulty associated with the problem completed when the performance event occurs. For example, in a lesson where the problems get increasingly more difficult, answering the last question correctly causes the progress meter to increment by a larger amount than answering the first question correctly.

When the progress meter reaches a designated level (e.g., when the meter is full), this indicates that the student has achieved a goal and the system accumulates the appropriate number of tokens for the student. In this manner, the progress meter gives the student a visual representation of how close he or she is to meeting a certain goal at any given time during the lesson. Additionally, the progress meter serves as a motivation mechanism to encourage the student to continue working towards that goal.

In one embodiment, when the determination is made that a student has earned or accumulated one or more tokens based on the student's performance during the lesson, the system automatically provides any accumulated tokens to the student. The system may enable a teacher to award tokens to a student, such as on a discretionary basis, for the student's performance on the lesson, a series of lessons, or for any other suitable reason. For example, in a learning environment where a student completes a lesson on a tablet computer which includes a pen or stylus-based input and display, a teacher may “hand out” tokens by using a coded stylus to slide a number of electronic tokens from a displayed teacher wallet area to a displayed student wallet area.

The number of tokens accumulated by the student may be stored by the system for tracking purposes. For example, the number of tokens accumulated by a student may be stored in a student profile associated with the student. The student may have the opportunity, at any time and through network communication with the student profile, to monitor token balances. For example, the student may access an electronic student checkbook which shows the student how may tokens he or she has earned in a designated period of time, such as a single lesson, a single learning session, one day, one week, or a year. The student checkbook may show a total number of tokens earned by the student.

The system may enable the student to view offerings of awards or prizes for which accumulated tokens may be redeemed, such as through a virtual store. When the student earns a number of tokens that matches with a particular award or prize made available for that number of tokens, the system may enable the student to request that award or prize. The system may highlight or otherwise indicate to the student which prizes the student has enough tokens to obtain, while other prizes that are worth more tokens remain dimmed or shaded. In this manner, the system provides another motivation mechanism by enabling a student to see what prizes could be obtained if he or she were to accumulate even more tokens.

Accordingly, the system disclosed herein provides redeemable tokens to a student based on occurrences of designated performance events which are tracked in association with a lesson. By providing multiple types of peformance events which can contribute to the accumulation of tokens, the system disclosed herein enables a more granular approach to rewarding a student based on his or her performance.

Additional features and advantages are described herein, and will be apparent from the following Detailed Description and the figures.

### BRIEF DESCRIPTION OF THE DRAWINGS

FIG. 1 is a block diagram showing one example of a network communications system for implementing the system disclosed herein.

FIG. 2 is a more detailed block diagram showing one example of a computing device.

FIG. 3 is a flowchart of an example process for rewarding a student with tokens based on the student's performance in a lesson.

FIGS. 4 to 24 are screen shots of a display device of a student computing device in one example of the system disclosed herein.

### DETAILED DESCRIPTION

The disclosed system enables rewarding a student with redeemable tokens based on the student's performance on instructional material, such as one or more lessons provided to a student computing device.

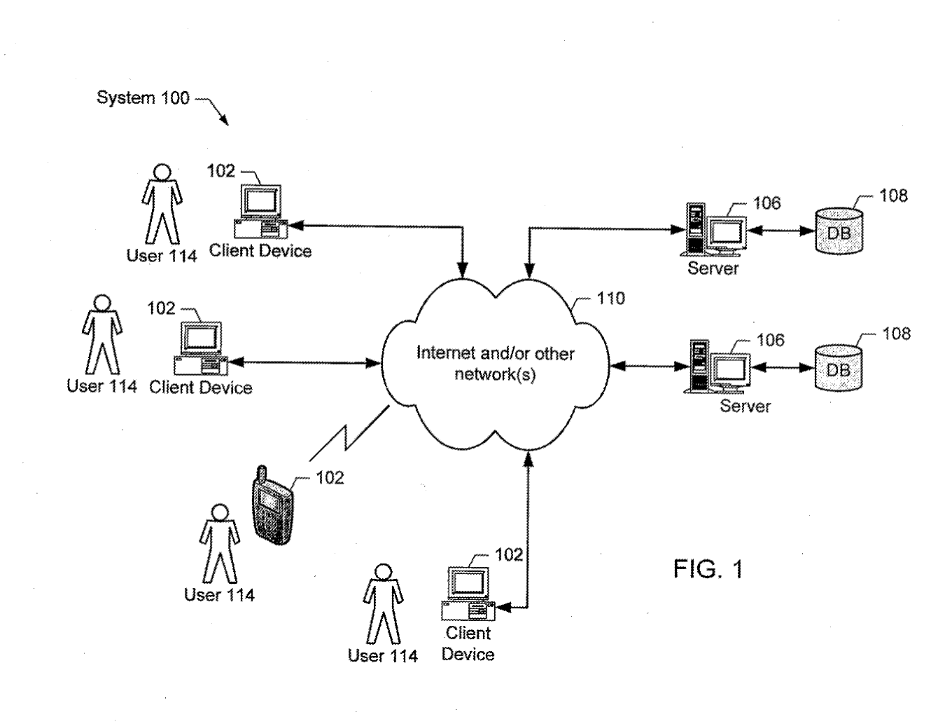

Referring now to FIG. 1, the disclosed system may be realized in a network communications system. A high level block diagram of an exemplary network communications system 100 is illustrated in FIG. 1. The illustrated system 100 includes one or more client devices 102, one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102. The databases 108 may be connected directly to the web server 106 and/or via one or more network connections.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

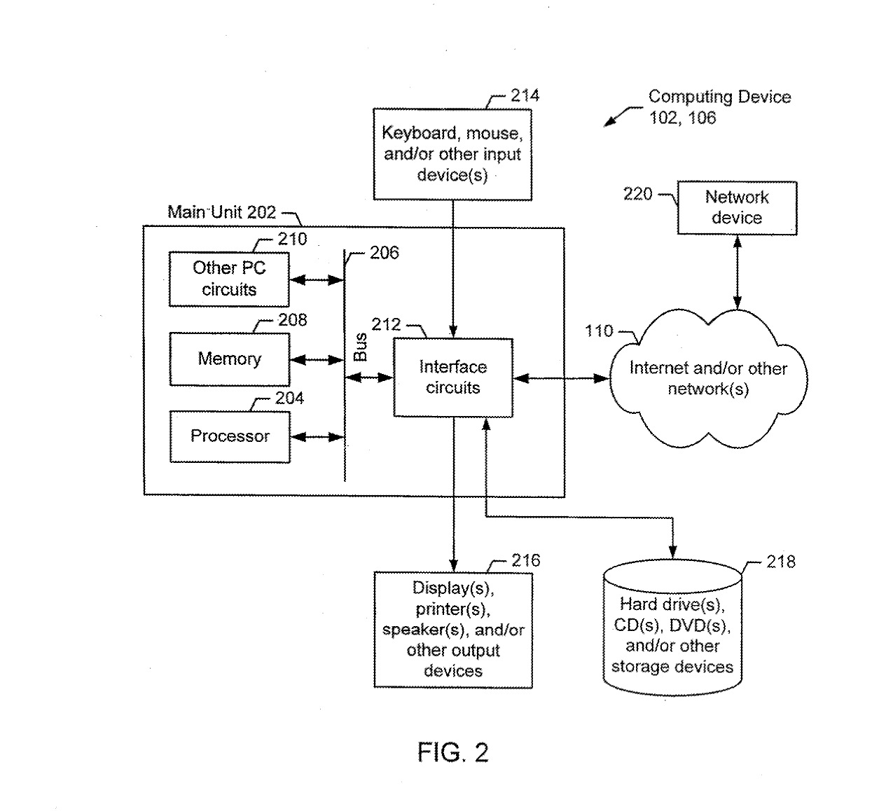

A more detailed block diagram of the electrical systems of a computing device (e.g., client device 102 and/or server 106) is illustrated in FIG. 2. Although the electrical systems of a client device 102 and a typical server 106 may be similar, the structural differences between the two types of devices are well known.

The client device 102 may include a personal computer (PC), a tablet-style computer, a personal digital assistant (PDA), an Internet appliance, a cellular telephone, or any other suitable communication device. The client device 102 includes a main unit 202 which preferably includes one or more processors 204 electrically coupled by an address/data bus 206 to one or more memory devices 208, other computer circuitry 210, and one or more interface circuits 212. The processor 204 may be any suitable processor. The memory 208 preferably includes volatile memory and non-volatile memory. Preferably, the memory 208 stores a software program that interacts with the other devices in the system 100 as described below. This program may be executed by the processor 204 in any suitable manner. The memory 208 may also store digital data indicative of documents, files, programs, web pages, etc. retrieved from a server 106 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the client device 102. For example, the display 216 may be used to display web pages and/or desktop pop-up data received from the server 106. The visual displays may include prompts for human input, run time statistics, calculated values, data, etc. Stylus-sensitive displays are currently available for use with tablet computers, and such displays may be used as device 216, as discussed below.

One or more storage devices 218 may also be connected to the main unit 202 via the interface circuit 212. For example, a hard drive, CD drive, DVD drive, and/or other storage devices may be connected to the main unit 202. The storage devices 218 may store any type of data or content used by the client device 102.

The client device 102 may also exchange data with other network devices 220 via a connection to the network 110. The network connection may be any type of network connection, such as an Ethernet connection, digital subscriber line (DSL), telephone line, coaxial cable, etc. Users 114 of the system 100, such as students, guardians, relatives, teachers, and directors, may be required to register with the server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

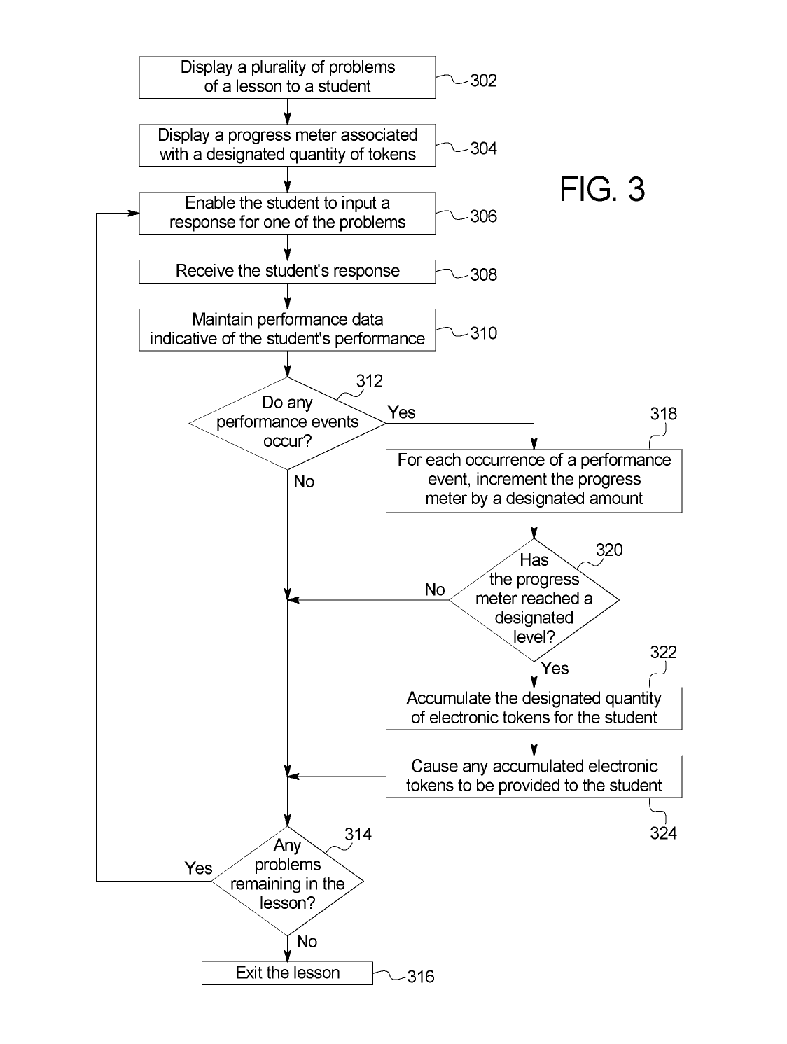

A flowchart of an example process 300 for rewarding a student based on the student's performance during a lesson is illustrated in FIG. 3. Preferably, the process 300 is embodied in one or more software programs which is stored in one or more memories and executed by one or more processors. Although the process 300 is described with reference to the flowchart illustrated in FIG. 3, it will be appreciated that many other methods of performing the acts associated with process 300 may be used. For example, the order of many of the steps may be changed, and many of the steps described are optional.

In general, the process 300 causes the computing device 102 to display a set of questions or problems of a lesson to a student (block 302). The process 300 causes the computing device 102 displays a progress meter in association with the lesson (block 304). The progress meter is associated with a designated number of tokens, such as one token.

The process 300 causes the computing device 102 to enable the student to input a response to one of the problems (block 306). The process 300 causes the computing device 102 to receive the student's response to the problem (block 308). As the student progresses through the lesson, the student's performance on the problems is tracked or monitored, and performance data indicative of the student's performance on the problems is maintained (block 310). For example, the performance data may include at least one of: (i) an amount of time required by the student to respond to each problem; (ii) whether a correct response was received from the student for each problem; and (iii) a level of difficulty associated with each problem; (iii) a total number of problems attempted, whether incorrect or correct answers were received; (iv) a total number of correct responses received from the student; (v) a number of consecutive correct responses received from the student; (vi) an amount of time required to respond to one, a plurality, or all of the problems; (vii) a total number of correct responses attempted at a designated level; or (viii) any other suitable data relating to the student's performance. Performance data is collected and maintained for each problem and may be analyzed to determine whether any performance events occur in association with the lesson.

The process 300 causes the computing device 102 to determine whether any designated performance events occur based on the performance data (diamond 312). For example, a designated performance event occurs if the response received from the student: (i) is a correct response; (ii) causes a designated number of correct responses to be met (e.g., the received answer was the 10^{th} correct response for the lesson); (iii) causes a designated number of consecutive correct responses to be met (e.g., the received answer was the 10^{th} consecutive correct response for the lesson); (iv) is received within a designated amount of time; (v) is partially correct (e.g., for a word problem, when the student applies the correct formula, regardless of whether the final answer is correct or incorrect; (vi) causes any other suitable performance criteria to be satisfied; or (vii) any suitable combination of these.

If the determination is made that no performance events have occurred, the process 300 causes the computing device 102 to determine whether there are any problems remaining in the lesson (diamond 314). If there are no problems remaining in the lesson, the process 300 causes the computing device 102 to enable the student to exit the lesson (block 316). If there are problems remaining in the lesson, the process 300 causes the computing device 102 to enable the student to input a response to a next one of the problems, and the process 300 repeats itself beginning at block 306.

If the determination is made that at least one performance event has occurred in connection with the lesson, for each occurrence of a performance event, the process 300 causes the computing device 102 to increment the progress meter by a designated amount (block 318). The amount by which the progress meter increments for each occurrence of a performance event may be a predefined amount or may be based on the type of performance event which occurs. Different types of performance events may cause the progress meter to increment by different amounts. For example, if a response received from the student is a correct response, this causes the progress meter to increment by a first amount. If the response is a correct response which is submitted within a predefined amount of time, this causes the progress meter to increment by a second, higher amount.

The contribution that each performance event makes toward the accumulation of the designated number of tokens (or the amount by which the performance event causes the progress meter to increment) may be represented by a quantity of points (or any other suitable unit or item which may be accumulated or tracked, such as displayed stars). Each time a performance event occurs, the amount by which the progress meter increments corresponds to the number of points associated with that performance event. For example, a progress meter displayed in association with a lesson must increment to ten for the student earn one token. Getting a correct answer is worth one point, and getting five correct answers in a row is worth three points. Each time the student provides or enters a correct answer during the lesson, the meter increments by one. When the student gets the fifth consecutive correct answer, the meter increments by three. When the meter increments to ten, the student earns the token. Thus, different types of performance events may have different values. In other words, different types of performance events may contribute differently toward the accumulation of tokens.

It should be appreciated that multiple performance events may occur simultaneously. For instance, a student may respond to a problem correctly, and answering that problem correctly may cause the student to meet a designated number of consecutive correct answers (e.g., five correct answers in a row). As a result, the student obtains a first number of points (or stars) for getting the correct response, as well as a second number of points (or stars) for achieving a designated number of consecutive correct responses. The student may be provided with an additional number of extra or bonus points (or stars) if multiple performance events occur simultaneously.

The amount by which the progress meter increments may be based on a level of difficulty associated with the problem completed when the performance event occurs. For example, in a lesson where the problems get increasingly more difficult, answering the last question of the lesson correctly causes the progress meter to increment by a larger amount than answering the first question correctly.

Referring back to FIG. 3, after incrementing the progress meter based on any performance events which occur in connection with the lesson, the process 300 causes the computing device 102 to determine whether the progress meter has reached a designated level (diamond 320). If the determination is made that the progress meter has not reached the designated level, this means that the student has not yet reached the goal of earning of the designated number of tokens. The process 300 causes the computing device 102 to determine if there are any problems remaining in the lesson (diamond 314). If there are no problems remaining in the lesson, the process 300 causes the computing device 102 to enable the student to exit the lesson (block 316). If there are problems remaining in the lesson, the process 300 causes the computing device 102 to enable the student to input a response to a next one of the problems, and the process 300 repeats itself beginning at block 306.

It should be appreciated that, as the student continues to work through the lesson, the progress meter gives the student a visual representation of how close he or she is to earning the designated number of tokens at any given time. In this manner, the progress meter functions as a motivation mechanism to encourage the student to continue working towards that goal.

In the example process 300 of FIG. 3, the student's performance on the problems is monitored as the student works through the lesson and the incrementing of the meter occurs in real time. In one embodiment, the process 300 causes the computing device 102 to wait until the lesson is complete to analyze the performance data, determine whether any performance events have occurred, and increment the meter accordingly. In another embodiment, the process 300 causes the computing device 102 to assess whether to increment the meter at designated times during the lesson, such as at designated time intervals or after a designated number of problems have been completed.

If the determination is made that the progress meter reaches a designated level (e.g., if the meter is full), this indicates that the student has earned the designated number of tokens. The process 300 causes the computing device 102 to accumulate the designated number of tokens for the student (block 322). The computing device 102 may inform the student of the quantity of tokens awarded or accumulated by displaying them to the student. The process 300 causes the computing device 102 to cause any accumulated tokens to be provided to the student (block 324). As discussed in detail below, accumulated tokens may be redeemed by the student for one or more awards or prizes.

In one embodiment, when the determination is made that a student has earned or accumulated one or more tokens based on his or her performance during the lesson, the accumulated token(s) are automatically provided to the student. Alternatively or additionally, a teacher input may be required for any accumulated tokens to be provided to the student.

After causing any accumulated tokens to be provided to the student, the process 300 causes the computing device 102 to determine if there are any problems remaining in the lesson (diamond 314). If there are no problems remaining in the lesson, the process 300 causes the computing device 102 to enable the student to exit the lesson (block 316). If there are problems remaining in the lesson, the process 300 causes the computing device 102 to enable the student to input a response to a next one of the problems, and the process 300 repeats itself beginning at block 306.

The number of tokens accumulated by the student may be stored by the system for tracking purposes. For example, the number of tokens earned by a student may be stored in a student profile associated with the student. As discussed below, the student may have the opportunity, at any time and through network communication with the student profile, to monitor token balances. For example, the student may access the student profile to see how many tokens he or she has earned in a designated period of time.

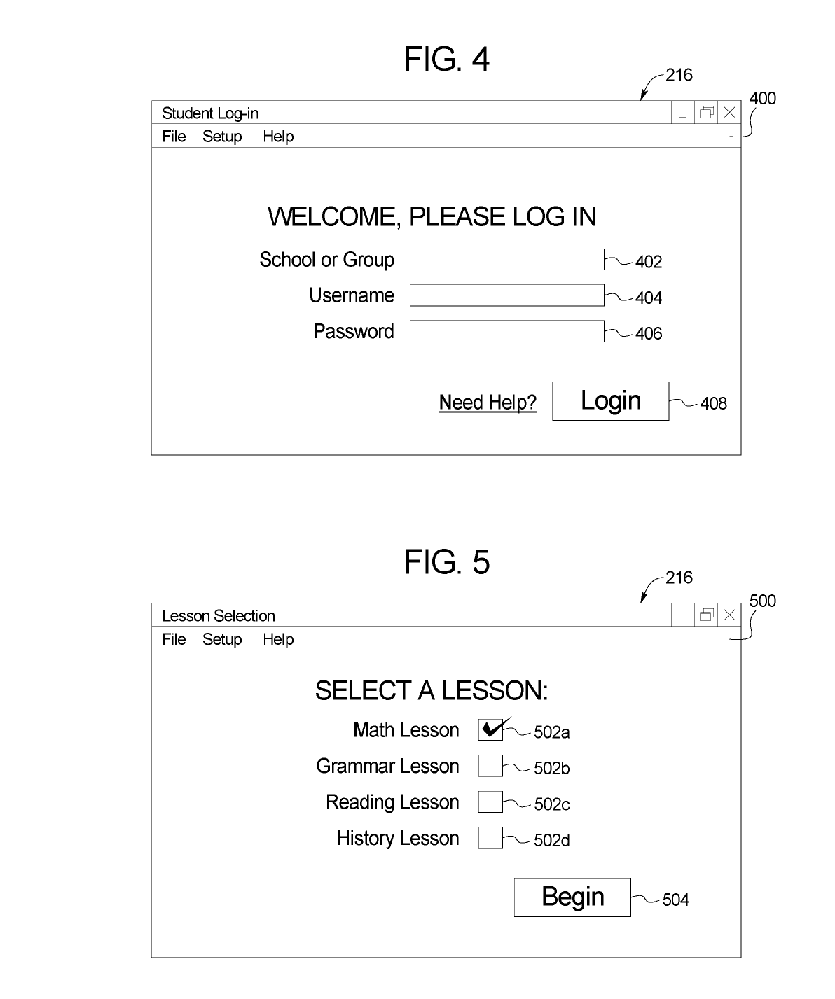

Referring now to FIGS. 4 to 23, in one example, the system is implemented in a learning environment the student works on instructional materials provided to a student computer 102. Selected instructional materials or programs (e.g., lessons), may be provided to the computer 102 either by the network, as described below, or run from a hard disk, RAM or other storage device on the computer itself.

FIG. 4 illustrates a close-up view of the display 216 of the computer 102. More particularly, FIG. 4 is a screen shot of an exemplary login screen 400 for a student who is about to begin working on a lesson. The login screen 400 may include a school or group text entry field 402 for the student to enter a school or group name or identification. A username text entry field 404 and password text entry field 406 may also be provided to enable the student to maintain privacy of their information. A soft-button 408 may be provided for the student to select for submission of the information in the text entry fields 402, 404, and 406. The system accepts the login information from the student and authenticates the student, such as by accessing a database to confirm that the user is a student as provided by a student profile.

FIG. 5 is a screen shot of an exemplary lesson selection screen 500 for the student. The lesson selection screen 500 may include a number of selectable options or boxes 502a, 502b, 502c, and 502d which each correspond to a lesson to be completed by the student. For example, as illustrated in FIG. 5, the selectable options or boxes 502a, 502b, 502c, and 502d include “Math Lesson,” “Grammar Lesson,” “Reading Lesson,” and “History Lesson.” The student may select a lesson by selecting one of the boxes 502a, 502b, 502c, and 502d. A “Begin Lesson” soft-button 504 may be provided for the student to select or activate for submission of the lesson selection.

The system causes the computer 102 to enable the student to input lesson selections, responses to problems, or any other suitable command via one or more input devices. In one example, the computer 102 is a tablet computer having a touch-sensitive display device (e.g., a touch screen), configured to detect contact by a user's finger or a stylus. A user (e.g., a student or teacher) may have a stylus which is associated with or coded to that user. When a user utilizes his or her stylus to make inputs via the touchscreen, the computing device 102 associates any information or commands inputted with the owner of that stylus. It should be appreciated that other types of input devices, such as a mouse, trackball, a scroll wheel, a fingerprint reader, a touch pad, a sweep sensor, or the like may also be used with the tablet computer. One of more of these devices may be integrated with the tablet computer and/or exist separately.

Referring back to FIG. 5, the student selects the first box 502a, which corresponds to the Math Lesson. In response to the submission of the student's lesson selection, the computer 102 causes lesson content to be displayed to the student.

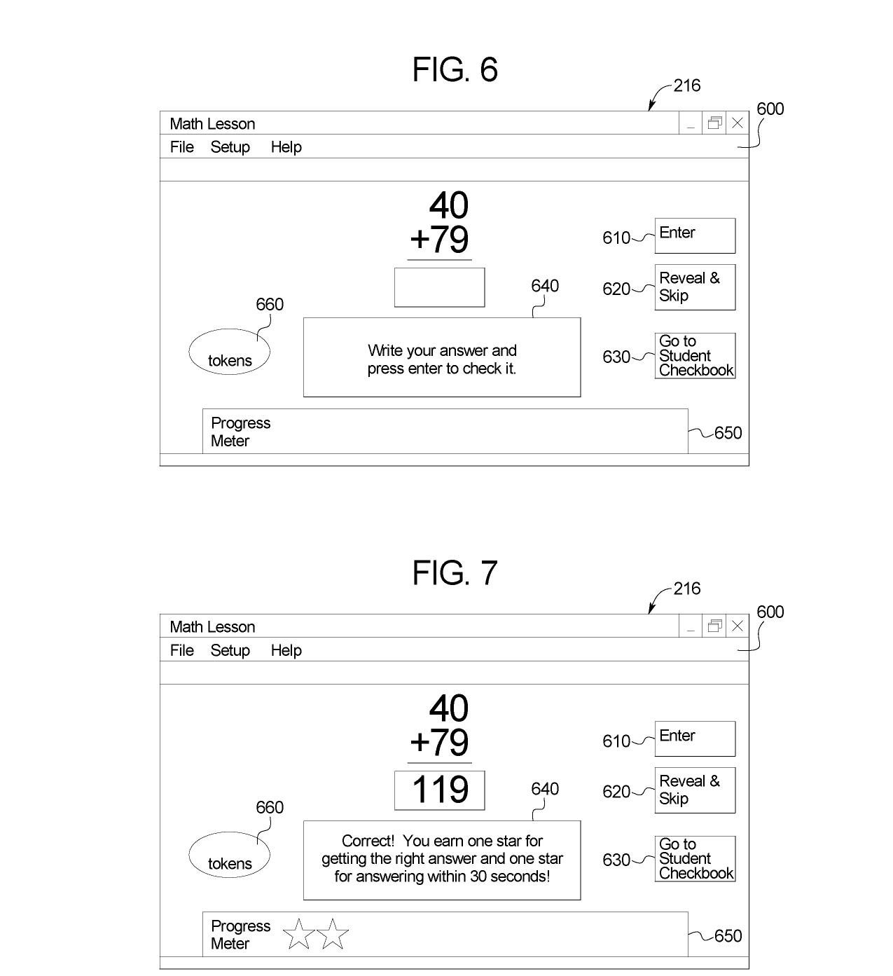

More particularly, as illustrated in FIG. 6, a lesson screen 600 displays the first math problem of a series of ten math problems in the lesson. In the illustrated example, the ten problems of the lesson are generated and displayed in a game-like format. It should be appreciated that, although the illustrated example relates to a math lesson the present disclosure may be practiced using any type of educational criteria and problems. Also, even though a game-like format is used in this example, any suitable format can be used for presenting problems during a lesson.

As illustrated in FIG. 6, in addition to the first math problem, the lesson screen 600 displays an “Enter” button 610, a “Reveal and Skip” button 620, a “Go to Student Checkbook” button 630, and a message display area 640 for displaying messages to the student regarding the lesson. The lesson screen 600 also displays a progress meter 650 and a token counter 660 in association with the lesson. The progress meter 650 displays or conveys information to the student about the student's progress toward earning a token. The token counter 660 displays the student's overall token total 104 for the lesson.

As will be discussed below, for each occurrence of a designated performance event in association with the lesson, the system causes the progress meter 650 to increment. In this example, a designated performance event occurs when any one of: (i) the student's response to a problem is a correct response; (ii) the student gets a designated number of correct responses during the lesson; (iii) the student gets a designated number of consecutive correct responses during the lesson; (iv) the student provides a correct answer within a designated amount of time (e.g., thirty seconds); and (v) the student's answer is partially correct (e.g., for a word problem, the student applies the correct formula, regardless of whether the final answer is correct or incorrect.

In the illustrated example, each increment of the progress meter 650 is represented by displaying a star in the progress meter. In the illustrated embodiment, the number of increments (e.g., stars) provided to the student for each occurrence of a designated performance event varies based on the type of performance event which occurs and the level of difficulty selected associated with the problem. When the student accumulates ten stars in the progress meter 650, the student earns a token. By providing multiple types of peformance events which contribute to the accumulation of the token, the system disclosed herein enables a more granular approach to rewarding a student based on his or her performance.

As illustrated in FIG. 6, the first math problem of the lesson is “40+79=______”. The message display area 640 displays a suitable message prompting the student to answer the problem and press the Enter button 610 to check the answer.

In the illustrated example, the student answers the displayed problem by physically entering the answer on the screen. Using a stylus, the student solves the problem and inputs an answer to the problem via the touch screen.

As illustrated in FIG. 7, the student has performed the calculation indicated by the displayed problem and has entered an answer. More specifically, the student has entered the number “119” as the answer to the problem. The student presses the enter button 610 to check the answer, but it should be appreciated that any suitable button could be used to check the student answer.

The answer supplied by the student, “119”, is correct as indicated by the message displayed in the message display area 640. In addition, message indicates that the student has earned one star for getting the correct answer and one star for answering the question within 30 seconds. As indicated by the progress meter 650, two stars are displayed in the progress meter. The token counter 660 is empty indicating that the student has not yet accumulated any tokens in this lesson.

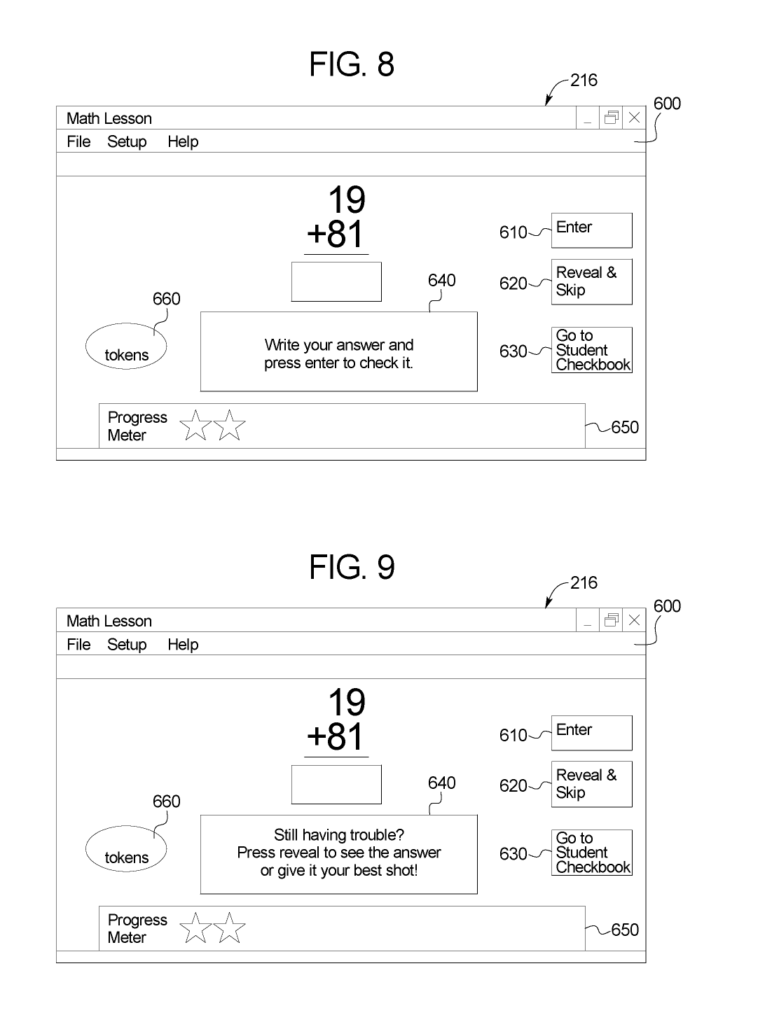

After displaying the stars in the progress meter 650, the lesson automatically advances to the next displayed problem. As illustrated in FIG. 8, the second math problem of the lesson is “19+81=______”. The message display area 640 displays a suitable message prompting the student to answer the problem and press the Enter button 610 to check the answer.

Referring now to FIG. 9, some time has elapsed and the student has not yet answered the problem. The message displayed by the message display area 640 encourages the student to either press the Reveal and Skip button 620 to see the correct answer, or to give the problem a try. The student may activate the Reveal and Skip button 620 when they do not know or are having trouble calculating a correct response to a displayed problem, thereby skipping the problem. In this example, activating the Reveal and Skip button 620 enables the student to view the answer to the displayed problem and causes the lesson to automatically advance to the next problem. In one embodiment, the student gains no stars if he or she chooses to activate the Reveal and Skip button 620. In one embodiment, the system may deduct stars from the student for activating the Reveal and Skip button 620. In one embodiment, the number of times the student activates the Reveal and Skip button 620 and the problem associated with activating the Reveal and Skip button 620 are recorded, thereby offering further insight into the student's progress or performance.

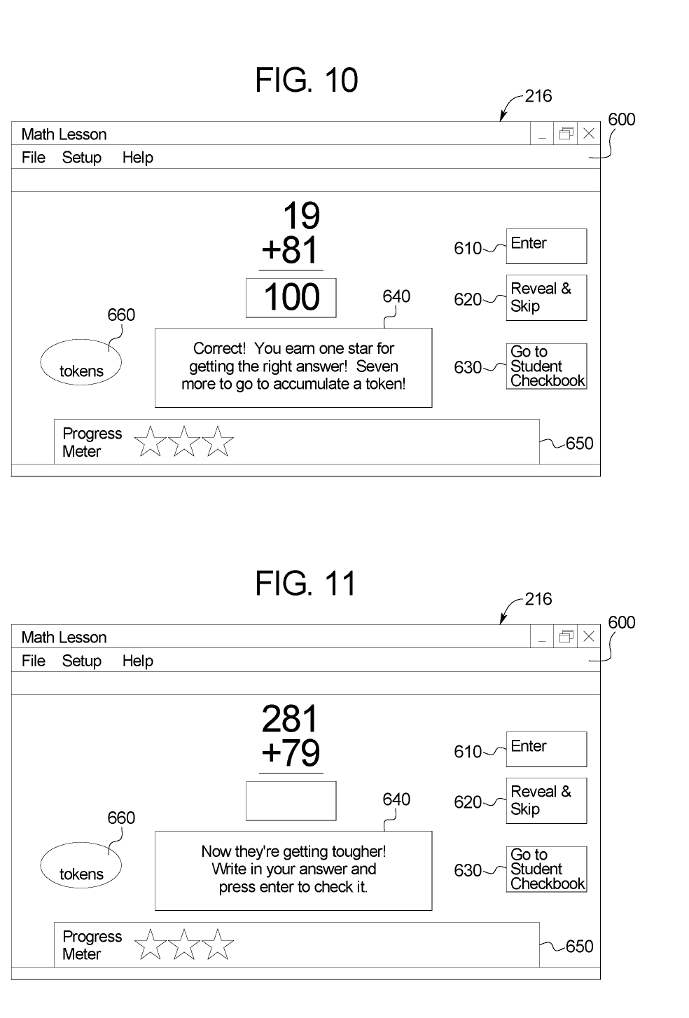

Referring now to FIG. 10, the student has performed the calculation indicated by the displayed problem and has entered an answer. The answer entered by the student is the number “100” As described above, the student presses the enter button 610 to check the answer.

The answer is correct, as indicated by the message displayed in the message display area 640. In addition, the message informs the student that they have earned one additional star for getting this correct answer. It should be appreciated that, since it took the student a long time to answer the question, no star is awarded for getting the answer within thirty seconds.

As seen in FIG. 10, the progress meter 650 has another star displayed in it. There are a total of three stars displayed in the progress meter 650, which means that the student needs seven more stars to accumulate a token. Seeing the stars accumulate across the bottom of the lesson screen 600 gives the student a visual indication of how close the student is to achieving the goal of accumulating a token. Thus, the progress bar serves as a motivation mechanism to encourage the student to continue working toward that goal.

After displaying the additional star in the progress meter 650 for getting the correct answer for the second problem, the lesson automatically advances to the next displayed problem.

As illustrated in FIG. 11, the third math problem of the lesson is displayed to the student. The displayed problem is 281+79=______. The message display area 640 displays a suitable message prompting the student to answer the problem and press the Enter button 610 to check the answer. As also indicated by the message display area, the problems appear to be getting more difficult. As described above, the number of stars provided to the student for each occurrence of a designated performance event varies based on the type of performance event which occurs and the level of difficulty selected associated with the problem. Therefore, the student has the opportunity to earn even more stars for achieving certain performance-based criteria (e.g., a correct answer, a certain response time, etc) on this more difficult problem.

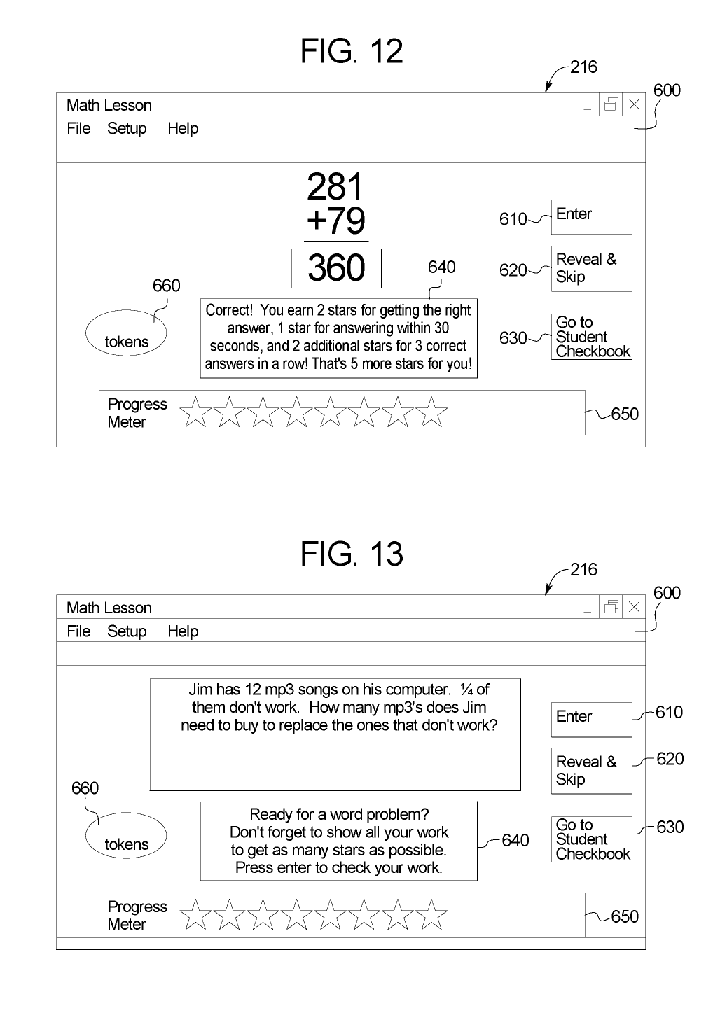

In FIG. 12, the student has performed the calculation indicated by the displayed problem and has entered an answer. The answer entered by the student is the number “360.” As described above, the student presses the enter button 610 to check the answer.

The answer is correct, as indicated by the message displayed in the message display area 640. In addition, the message informs the student that they have earned two stars for getting this correct answer, one star for answering the problem within thirty seconds, and two stars for getting the third consecutive correct answer. In other words, three different performance events occurred. First, the student got the correct answer; second, the student got the correct answer within the predefined response time of thirty seconds; third, the student answered three consecutive problems correctly. Based on the occurences of these three separate performance events, the student earns a total of five stars. It should be appreciated that the number of stars the student received for getting the correct answer to the third problem (two stars) is higher than for the first and second problems because this problem was more difficult.

As seen in FIG. 12, the progress meter 650 has another five stars displayed in it. There are a total of eight stars displayed in the progress meter 650, which means that the student only needs two more stars to accumulate a token.

As illustrated in FIG. 13, the fourth math problem of the lesson is displayed to the student. The displayed problem is a word problem. The message display area 640 displays a suitable message prompting the student to answer the problem and press the Enter button 610 to check the answer. The message also informs the student to show all work on the word problem to maximize opportunities for earning stars. As described above, the system may determine that a performance event occurs when a student provides a partially correct answer, such as by providing a correct formula to apply to a problem, regardless of whether the final answer is correct or incorrect. This encourages the student to carefully work though the problem, showing all steps taken to arrive at the final answer.

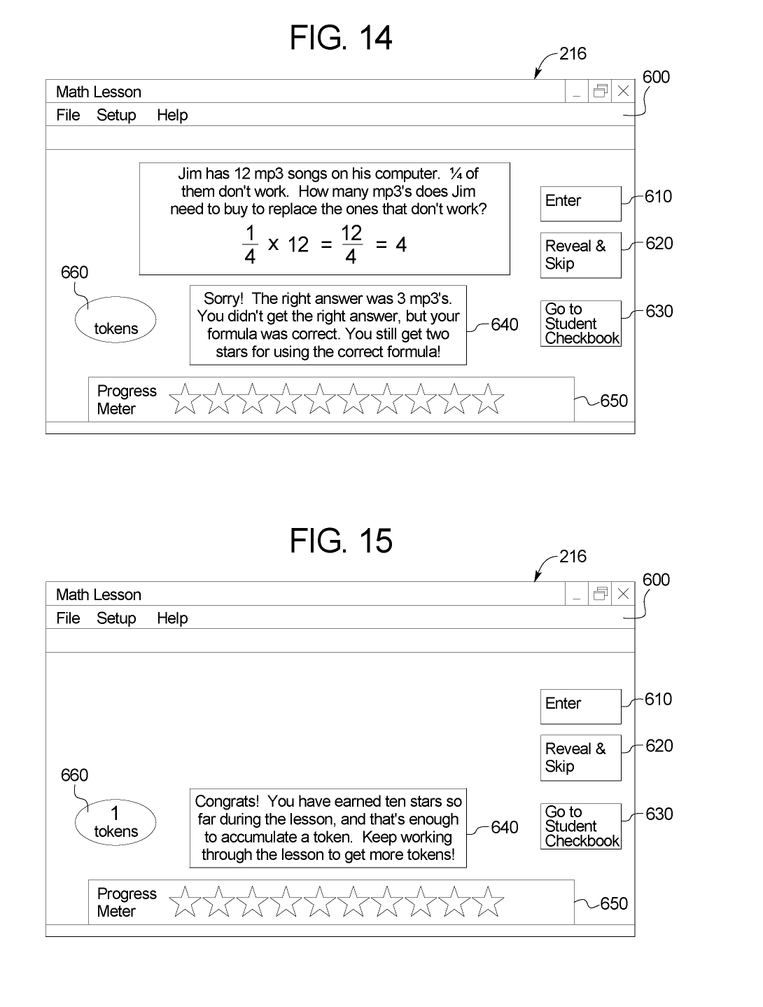

In FIG. 14, the student has entered an answer for the displayed word problem. The answer entered by the student includes the formula used by the student to calculate the final answer. The final answer entered by the student is “4.” As described above, the student presses the Enter button 610 to check the answer.

As indicated by the message in the message display area 640, the student did not get the correct answer. However, the student applied the correct formula. The student still earns two stars based on the student's performance on the word problem. As a result, another two stars are displayed in the progress meter 650. The progress meter 650 now includes ten stars, which is enough to accumulate the token for the student.

As illustrated in FIG. 15, the message displayed in the message display area 640 congratulates the student for earning ten stars and, as a result, accumulating a token. The token counter 660 now shows the number “1” which indicates that the student has earned a total of one token so far in the lesson.

In this example, the progress meter 650 resets to zero after the student gets the required number (e.g., ten) of stars and, thus earns a token. If there are problems remaining in the lesson when the progress bar is reset, the student may continue accumulating stars in the progress meter 650 to try to earn another token.

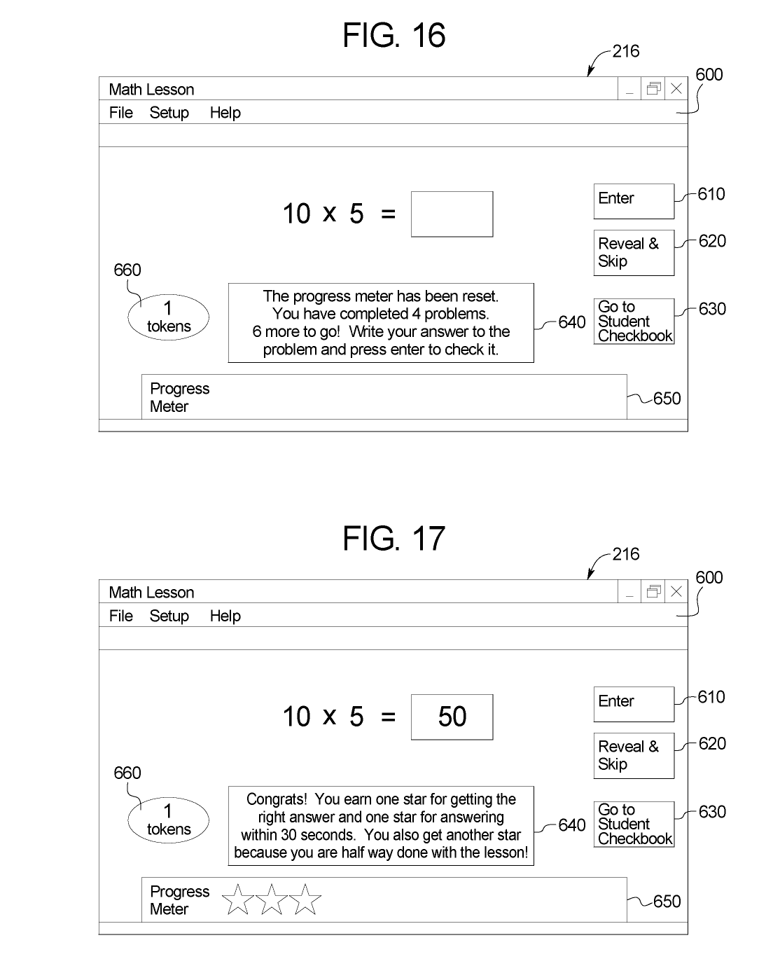

As illustrated in FIG. 16, the progress meter 650 has been reset. There are still six more problems in the lesson. Accordingly, the student will have more opportunities to cause the progress meter 650 to increment in attempt to accumulate more tokens during the lesson. A next problem of the lesson (the fifth problem) is displayed to the student. The fifth problem is 10×5=______. The message display area 640 displays a suitable message prompting the student to answer the problem and press the Enter button 610 to check the answer.

As illustrated in FIG. 17, the student has performed the calculation indicated by the displayed problem and has entered an answer. The answer entered by the student is the number “50.” As described above, the student presses the enter button 610 to check the answer.

The answer is correct, as indicated by the message displayed in the message display area 640. In addition, the message informs the student that they have earned one star for getting this correct answer and one star for answering the problem within thirty seconds. The message also indicates that the student earns another star for being at the half-way point in the lesson (e.g, completing five of the ten questions of the lesson). Accordingly, three stars are displayed in the progress meter 650. This means that the student needs seven more stars to accumulate another token.

After displaying the three stars earned in connection with the fifth problem, the lesson automatically advances to the next displayed problem.

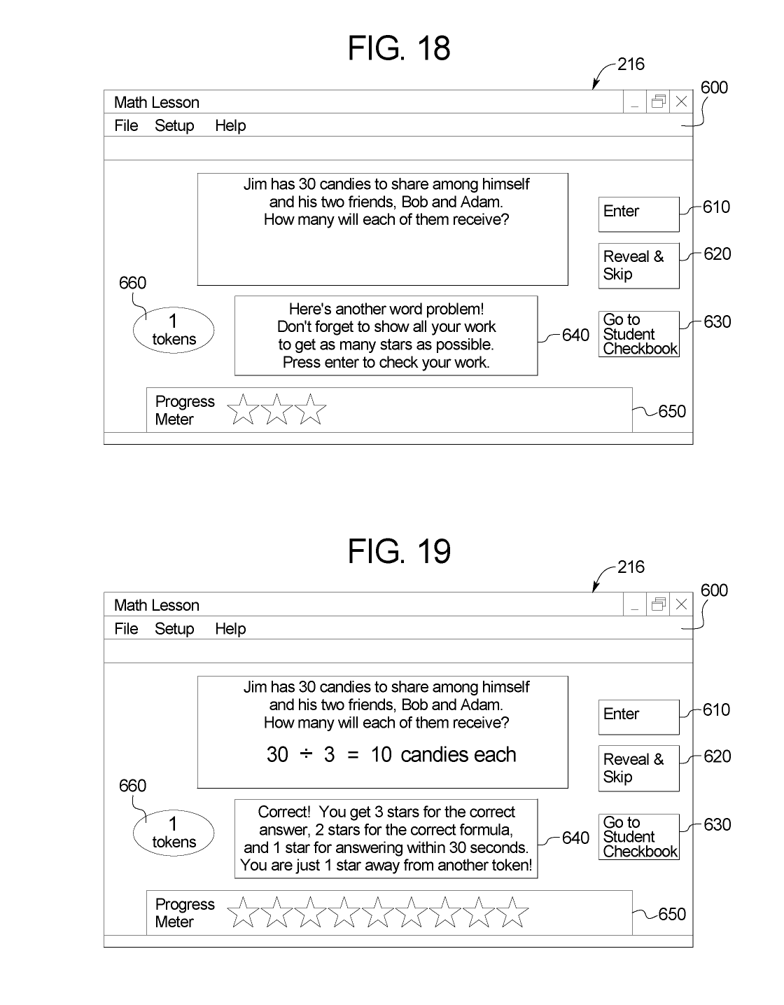

As illustrated in FIG. 18, the sixth math problem of the lesson is displayed to the student. The displayed problem is a word problem. The message display area 640 displays a suitable message prompting the student to answer the problem and press the Enter button 610 to check the answer. The message reminds the student to show all work on the word problem to maximize opportunities for earning stars.

In FIG. 19, the student has entered an answer for the displayed word problem. The answer entered by the student includes the formula used by the student to calculate the final answer. The final answer entered by the student is “10.” As described above, the student presses the Enter button 610 to check the answer.

As indicated by the message in the message display area 640, the student entered the correct answer. Also, the student used the correct formula to arrive at this answer. The student answered the problem within thirty seconds. Accordingly, as indicated by the message in the message display area 640, the student earns three stars for getting the correct answer, two stars for using the correct formula, and one star for answering the problem within thirty seconds. Thus, another six stars are displayed in the progress meter 650. The progress meter 650 now includes nine stars—only one star away from accumulating another token.

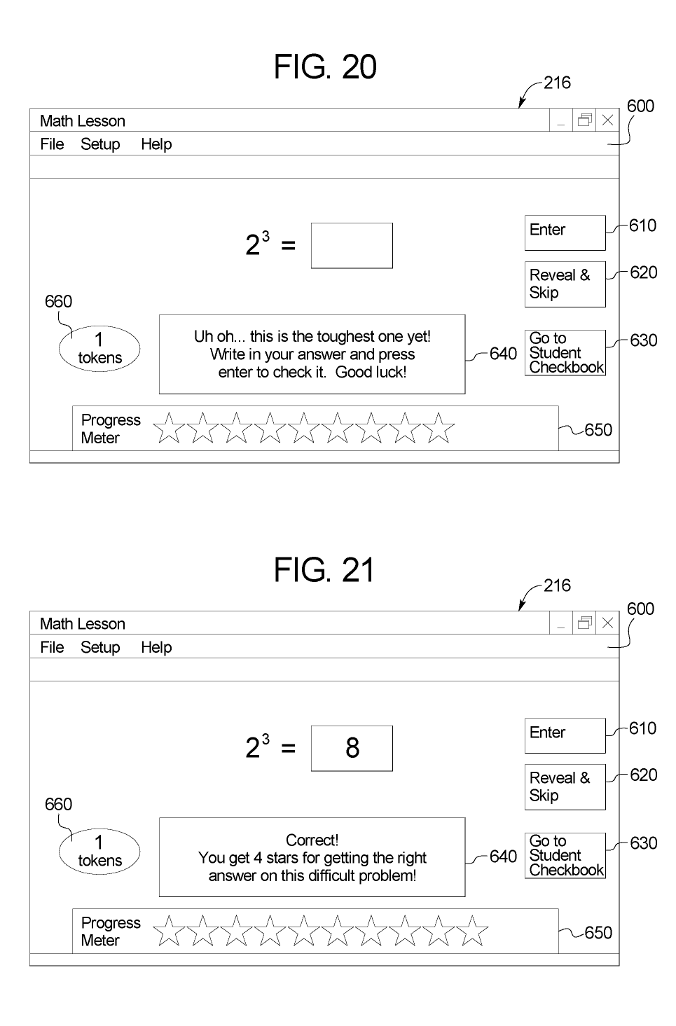

As illustrated in FIG. 20, the seventh problem of the lesson is displayed to the student. The seventh problem is 2³=______. This problem involves exponents and, as indicated by the message displayed in the message display area 640, is the most difficult problem in the lesson so far.

In FIG. 21, the student has performed the calculation indicated by the displayed problem and has entered an answer. The answer entered by the student is the number “8.” As described above, the student presses the enter button 610 to check the answer.

The student's answer is correct, as indicated by the message displayed in the message display area 640. In addition, the message informs the student that they have earned four stars for getting this correct answer. The number of stars earned for this problem is high due to the level of difficultly associated with this problem. Since the progress meter 650 previously included nine stars, one of the four stars earned by the student for the seventh problem goes toward accumulating the second token. The remaining three stars earned by the student for the seventh problem will be displayed in the progress meter 650 after it is reset. Those three stars will go toward accumulating the next (e.g., third) token.

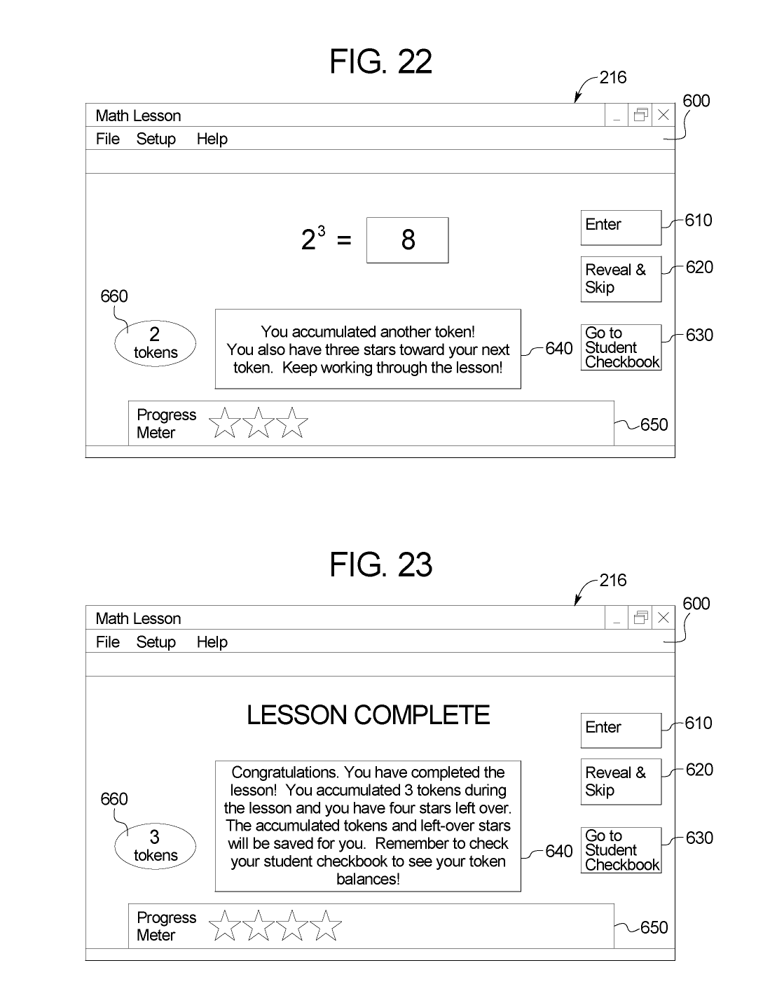

Accordingly, as illustrated in FIG. 22, the token counter 660 shows the number “2” which indicates that the student has accumulated another token during the lesson. Also, three stars are displayed in the progress meter 650.

In one embodiment, the system may enable a teacher to award tokens to a student on a discretionary basis for the student's performance on the lesson and/or a series of lessons or for any other suitable reason. In an example, in a learning environment where a student completes the lesson on a tablet computer, a teacher may periodically “hand out” tokens by using a coded teacher stylus to slide a number of electronic tokens from a teacher wallet area displayed on the screen of the tablet computer to a student wallet area displayed on the screen of the tablet computer. Since the teacher uses a coded stylus to slide these tablet tokens from the teacher wallet area to the student wallet area, the computing device 102 associates this command with the teacher and gives the teacher access to transfer a number of tablet tokens to the student. Alternatively or additionally, the teacher may be required to log-in or provide other identifiying information, such as a teacher PIN, to transfer such tablet tokens to the student.

In FIG. 23, skipping ahead to the end of the lesson, the message displayed in the message display area 640 indicates that the student has completed the lesson. The message provides a summary of the tokens and stars earned by the student. More particularly, as indicated by the message, the student accumulated three tokens based on the student's performance during the lesson. The student also has four stars left over.

The tokens and/or stars may be stored or saved for the student. For example, any tokens/stars accumulated or earned by the student when a lesson ends may be saved for later use (such as with a later lesson), so as to allow the student to pick up at the point where he/she left off in the previous lesson.

The number of tokens and/or stars accumulated by the student may be stored by the system for tracking purposes. For example, the number of tokens earned by a student may be stored in a student profile associated with the student. The student may have the opportunity, at any time and through network communication with the student profile, to monitor token balances. For example, by activating the “Go to Student Checkbook” button 630, the student may access an electronic student checkbook which shows the student how may tokens he or she has earned in a designated period of time, such as a single lesson, a single learning session, one day, one week, and/or a total number of tokens earned by the student.

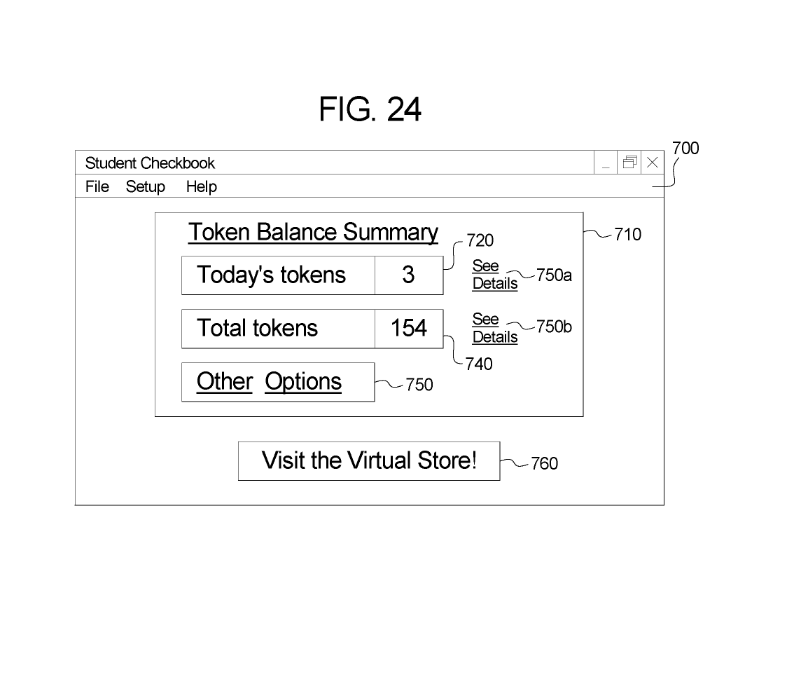

As illustrated in FIG. 24, the display device 216 displays a student checkbook screen 700. The student checkbook screen 700 includes a Token Balance Summary window 710, which provides information about the number of tokens that the student has accumulated. In the illustrated example, the Token Balance Summary window 710 includes a “Today's Tokens” display area 720 and an associated “See Details” button 750a. The Today's Tokens display area 720 displays the number of tokens that the student has accumulated in that day. For example, as illustrated in FIG. 24, the student accumulated three tokens that day. By activating the See Details button 750a, the student can view a further break-down of how and/or when the three tokens were accumulated, such as the lesson in which they were accumulated. The Token Balance Summary window 710 also includes a “Total Tokens” display area 740, which displays the total number of tokens that the student has earned, and an “Other Options” button 750. By activating the Other Options button 750, the student may have the option to sort token balance data in a number of different ways. For example, the system may enable the student to view and sort data relating to the number of tokens accumulated over any given period of time, such as a semester, a year, or five years. In another example, the system may enable the student to view and sort data relating to the number of tokens accumulated for any given subject area, such as math, reading, history, or any other suitable subject. In another example, the system may enable the student to view and sort data relating to a number of tokens spent or redeemed on prizes and awards. It should be appreciated that the student checkbook screen 700 may be configured to display any suitable data relating to token balances and may incorporate any suitable number or type of display areas and buttons.

The system may enable the student to view offerings of awards or prizes for which accumulated tokens may be redeemed, such as through a virtual store. As illustrated in FIG. 24, the system enables a student to access the virtual store by activating the “Visit the Virtual Store” button 730. When the student earns a number of tokens that matches with a particular award or prize made available for that number of tokens, the student may elect to request that award or prize. The system may highlight or otherwise indicate to the student which prizes the student has enough tokens to obtain, while other prizes that are worth more tokens remain dimmed or shaded. In this manner, the system provides another motivation mechanism by enabling a student to see what prizes could be obtained if he or she were to accumulate even more tokens.

The student's performance data for one or more lessons may be stored by the system. An overall performance record is preferably maintained for the student. The performance record includes performance data relating to the student's overall performance. The performance record, including performance data derived from the student's performance on one or more lesson(s), may be sorted and viewed in multiple selectable formats. For example, performance data about the student's performance on one or more lessons may be sorted and compiled to create one or more progress reports. Such progress reports may be distributed to the student's teachers or relatives (e.g., parents) either online or on paper. The system may reward a student with additonal tokens for encouraging a relative to perform various activities, such as reviewing a progress report.

The above-described lesson employing the lesson screen 600 may be generated using computer software or the like. In some embodiments, the lesson runs on a personal computer and the students' performance data and/or token balance information are stored on a memory device within the personal computer.

In another alternative embodiment, the lesson is run from a centralized location such as a centralized computer or collection of computers (e.g., a server). Thus, the lesson is capable of being distributed to a number of students via a computer network, such as an internet or an intranet. In this fashion, each student is able to access the lesson using a client program (e.g., a web browser). Running the lesson from a centralized location enables each of the student's performance data and/or token balances to be recorded or maintained in a centralized location, thereby facilitating data compilation and analysis. Further, it enables a student to access lessons from a remote location.

In one embodiment, the system enables multiple students to compete for tokens over the network. For example, students located all over the state or all over the country can compete against each other to accumulate tokens.

In another alternative embodiment, the lesson runs on a handheld device or a handheld computing device. Suitable handheld computing devices include but are not limited to laptop or palmtop computers such as a personal digital assistants. Personal digital assistants are desirable in that they are generally programmable and can easily and inexpensively be configured to meet the needs of the present system. Additionally, most handheld computing devices include synchronization functions that allow data stored on a memory device within the handheld device to easily be transferred from the handheld device to another device such as a personal computer or a computer network. The students' performance data and/or token balance information can be temporarily stored on the handheld device and then transferred directly to a personal computer or a computer network via the handheld device's synchronization function.

In a further alternative embodiment, the lesson runs on a video game console. Accordingly, it should be appreciated that the apparatus for running problem lessons according to the present system can be any suitable device having a processor, a display and an input device for receiving input from the student.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A method of rewarding a student, said method comprising:
(a) electronically displaying a plurality of problems of a lesson to the student;
(b) enabling the student to electronically input responses for said problems;
(c) electronically receiving the student's responses;
(d) maintaining performance data indicative of the student's performance on said problems;
(e) determining if any designated performance events occur based on the performance data;
(f) if at least one designated performance event occurs, for said at least one designated performance event, accumulating a token in response to a teacher input; and
(g) causing any accumulated tokens to be provided to the student.

2. The method of claim 1 which includes, upon receiving a response for one of the problems from the student, comparing said received response with a predefined correct response for said one of the problems to determine whether the received response is correct.

3. The method of claim 1 which includes, upon receiving a response for one of the problems from the student, comparing an amount of time required for the student to input said response to a predefined response time.

4. The method of claim 1, wherein the performance data includes at least one of: (i) an amount of time required by the student to respond to each problem; (ii) whether a correct response was received by the student for each problem; and (iii) a level of difficulty associated with each problem.

5. The method of claim 1, which includes determining that one of said designated performance events occurs when at least one of: (i) a correct response is received from the student; (ii) a partially correct response is received from the student; (iii) a designated number of correct responses are received from the student; (iv) a designated number of consecutive correct responses are received from the student; and (v) a correct response is received from the student within a designated amount of time.

6. The method of claim 1, wherein the designated quantity of tokens includes one token.

7. The method of claim 1 which includes, displaying a progress meter in association with the lesson.

8. The method of claim 7 which includes, when the progress meter increments to a designated level, accumulating a designated quantity of tokens for the student

9. The method of claim 7, which includes, for each designated performance event which occurs, incrementing the progress meter by the designated amount.

10. The method of claim 9, wherein, for each designated performance event which occurs, the amount by which the progress meter increments is based on a type of performance event.

11. The method of claim 10, wherein different types of performance events cause the progress meter to increment by different amounts.

12. The method of claim 9, wherein, for each designated performance event which occurs, the amount by which the progress meter increments is based on a level of difficulty associated with the problem completed when said performance event occurs.

13. The method of claim 1, which includes automatically causing any accumulated tokens to be provided to the student.

14. The method of claim 1, which includes causing any accumulated tokens to be provided to the student includes causing an accumulated number of electronic tokens to be provided to the student.

15. The method of claim 1, wherein causing any accumulated tokens to be provided to the student includes causing an accumulated number of physical tokens to be provided to the student.

16. The method of claim 1, which includes causing an additional number of tokens to be provided to the student based at least in part on a teacher input.

17. The method of claim 16, which includes enabling the teacher to input instructions to transfer the additional number of tokens from a teacher wallet to a student wallet.

18. The method of claim 17, which includes enabling the teacher to input said instructions using a coded stylus.

19. The method of claim 1, which includes storing a total number of accumulated tokens in a student profile associated with the student.

20. The method of claim 19, which includes enabling the student to access said student profile to view token balance information.

21. The method of claim 1, wherein accumulated tokens are redeemable by the student for one or more awards.

22. The method of claim 1, which includes resetting the progress meter to zero after the progress meter increments to the designated level.

23. The method of claim 1, wherein the token has a first value at a first learning location and second different value at a second different learning location.

24. An apparatus for rewarding a student, the apparatus comprising:
a processor;
an input device operatively coupled to the processor;
a display device operatively coupled to the processor; and
a memory device operatively coupled to the processor, the memory device storing instructions to cause the apparatus to:
(a) display a plurality of problems of a lesson to the student;
(b) enable the student to input responses for said problems;
(d) receive the student's responses;
(e) maintain performance data indicative of the student's performance on said problems;
(f) determine if any designated performance events occur based on the performance data;
(g) if at least one designated performance event occurs, accumulating a token in response to a teacher input;
(h) cause any accumulated tokens to be provided to the student.

25. The apparatus of claim 24, wherein the instructions cause the apparatus to, upon receiving a response for one of the problems from the student, compare said received response with a predefined correct response for said one of the problems to determine whether the received response is correct.

26. The apparatus of claim 24, wherein the instructions cause the apparatus to, upon receiving a response for one of the problems from the student, compare an amount of time required for the student to input said response to a predefined response time.

27. The apparatus of claim 24, wherein the performance data maintained for each of said problems includes at least one of: (i) an amount of time required by the student to respond to each problem; (ii) whether a correct response was received by the student for each problem; and (iii) a level of difficulty associated with each problem.

28. The apparatus of claim 24, wherein the instructions cause the apparatus to determine that one of said designated performance events occurs when at least one of: (i) a correct response is received from the student; (ii) a partially correct response is received from the student; (iii) a designated number of correct responses are received from the student; (iv) a designated number of consecutive correct responses are received from the student; and (v) a correct response is received from the student within a designated amount of time.

29. The apparatus of claim 24, wherein the designated quantity of tokens includes one token.

30. The method of claim 24 which includes, displaying a progress meter in association with the lesson.

31. The method of claim 30 which includes, when the progress meter increments to a designated level, accumulating a designated quantity of tokens for the student

32. The method of claim 30, which includes, for each designated performance event which occurs, incrementing the progress meter by the designated amount.

33. The apparatus of claim 30, wherein the instructions cause the apparatus to, for each designated performance event which occurs, increment the progress meter by the designated amount.

34. The apparatus of claim 30, wherein, for each designated performance event which occurs, the amount by which the progress meter increments is based on a type of performance event.

35. The apparatus of claim 28, wherein different types of performance events cause the progress meter to increment by different amounts.

36. The apparatus of claim 30, wherein, for each designated performance event which occurs, the amount by which the progress meter increments is based on a level of difficulty associated with the problem completed when said performance event occurs.

37. The apparatus of claim 24, wherein the instructions cause the apparatus to automatically cause any accumulated tokens to be provided to the student.

38. The apparatus of claim 24, wherein the instructions cause the apparatus to cause any accumulated tokens to be provided to the student by causing an accumulated number of electronic tokens to be provided to the student.

39. The apparatus of claim 24, wherein the instructions cause the apparatus to cause any accumulated tokens to be provided to the student by causing an accumulated number of physical tokens to be provided to the student.

40. The apparatus of claim 24, wherein the instructions cause the apparatus to cause an additional number of tokens to be provided to the student based at least in part on a teacher input.

41. The apparatus of claim 40, wherein the instructions cause the apparatus to enable the teacher to input instructions to transfer the additional number of tokens from a teacher wallet to a student wallet.

42. The apparatus of claim 41, wherein the instructions cause the apparatus to enable the teacher to input said instructions using a coded stylus.

43. The apparatus of claim 24, wherein the instructions cause the apparatus to store a total number of accumulated tokens in a student profile associated with the student.

44. The apparatus of claim 43, wherein the instructions cause the apparatus to enable the student to access said student profile to view token balance information.

45. The apparatus of claim 24, wherein accumulated tokens are redeemable by the student for one or more awards.

46. The apparatus of claim 24, wherein the instructions cause the apparatus to reset the progress meter to zero after the progress meter increments to the designated level.

47. A method of rewarding a student, said method comprising:
(a) displaying a plurality of problems of a lesson to the student;
(b) enabling the student to input responses for said problems;
(c) receiving the student's responses;
(d) maintaining performance data indicative of the student's performance on said problems;
(e) determining if any designated performance events have occurred based on the performance data;
(f) causing physical tokens to be provided to the student; and
(g) electroncailly tracking the physical tokens.

48. The method of claim 47, further comprising:
(h) displaying a progress meter in association with the lesson;
(i) if at least one designated performance event occurs, for said at least one designated performance event, incrementing the progress meter by a designated amount; and
(j) when the progress meter increments to a designated level, accumulating a designated quantity of tokens for the student.
